(19) United States
(12) Patent Application Publication
(10) Pub. No.: US 2009/0097790 A1
(43) Pub. Date: Apr. 16, 2009

(54) Bearing For Four-Cycle Engine

(75) Inventors: Kengo Hidano, Kamakura-shi (JP); Hiroaki Izumi, Kamakura-shi (JP); Osamu Suzuki, Kamakura-shi (JP); Yusuke Matsuoka, Kamakura-shi (JP)

Correspondence Address: WOLF, BLOCK, SHORR AND SOLIS-COHEN LLP, 250 PARK AVENUE, 10TH FLOOR, NEW YORK, NY, 10177, US

(73) Assignee: Nippon Thompson Co., Ltd., Tokyo (JP)

(21) Appl. No.: 12/248,099

(22) Filed: Oct. 9, 2008

(30) Foreign Application Priority Data
Oct. 11, 2007 (JP) 2007-265725

(51) Int. Cl. F16C 19/22

(52) U.S. Cl. 384/418

(57) ABSTRACT

A bearing capable of enduring long use in a four-cycle engine is provided. The bearing is provided with a hollow cylindrical retainer 1 made of steel and rotatably retaining a plurality of needle rollers 4. The retainer 1 is subjected to a sulphonitriding treatment to form a sulphonitrided layer 11 on a surface of the retainer 1. The sulphonitrided layer 11 is made up of a nitrogen-compound single-layer 12 deposited on the surface of the retainer 1 made of steel, and a sulfur-compound porous layer 13 formed continuously on the nitrogen-compound single-layer 12 and forming a surface layer of the sulphonitrided layer 11.

### BACKGROUND OF THE INVENTION

1. Field of the Invention

This invention relates to a bearing for use in a four-cycle engine mounted on a two-wheel vehicle, an all-terrain vehicle or the like or mounted as an outboard engine or the like.

2. Description of the Related Art

An engine comprises a lot of components using bearings as typified by a connecting rod (hereinafter referred to as “con rod”) providing a connection between each of the pistons and the crankshaft. In particular, a bearing used in the big end of the con rod has a retainer for holding needle rollers. The retainer is interposed directly between the connecting hole drilled through the big end of the con rod and a crankpin for the purpose of sustaining high rpm. The wear resistance of the bearing is improved by plating the surface of the retainer holding the needle rollers with silver or copper. The reason for such improvement in wear resistance of the surface of the retainer is that the surface of the retainer comes into slipping contact with the connecting hole of the con rod as the con rod and the crankpin rotate at higher speed, and the slipping contact greatly affects the seizing resistance of the bearing. Such a manner of improving the wear resistance is described, for example, in Japanese Unexamined Patent Publication No. 2005-273897.

In another known bearing as described in Japanese Unexamined Patent Publication No. 2005-106204, the surface of a retainer is subjected to nitriding treatment for improving the wear resistance.

The bearing using the retainer as described above is lubricated by use of engine oil. The four-cycle engine is made up of a large number of components that differ in material and characteristics from each other. For this reason, in order to lubricate all the components, the engine oil includes various additives in existing circumstances.

Many of the additives contained in the engine oil may often include sulfur component such as zinc dialkyl dithiophosphate (ZnDTP). Because the sulfur component tends to chemically react with silver or copper, when engine oil as described above is used, the sulfur component contained in the engine oil chemically reacts with silver or copper included in the plating on the surface of the retainer to form silver sulfide or copper sulfide on the surface of the retainer.

Because the silver-sulfide or copper-sulfide layer newly produced in this way does not strongly adhere to the surface of the steel retainer, if the surface of the retainer is worn, the silver sulfide or copper sulfide layer easily flakes off. When the silver sulfide or copper sulfide layer removes in an early stage, the surface of the steel retainer is bared. As a result, the fluid lubrication applied to the surface of the retainer and the connecting hole may possibly be changed to mixed lubrication, which accelerates occurrence of seizing.

That is, the conventional bearing is disadvantageously incapable of enduring long use when employed for the four-cycle engine.

On the other hand, when a bearing such as described in Japanese Unexamined Patent Publication No. 2005-106204 is employed for the four-cycle engine, a chemical reaction does not occur between the sulfur component in the engine oil and the retainer. However, it is known from experiment results that the bearing with the retainer subjected to nitriding treatment has a shorter life than the bearing with the silver or copper-plated retainer in a hostile use environment such as in the engine. The cause is not clear as of now.

### SUMMARY OF THE INVENTION

It is an object of the present invention to provide a bearing capable of enduring long use in a four-cycle engine.

The present invention relates to a bearing for a four-cycle engine comprising a hollow cylindrical retainer made of steel and rotatably retaining a plurality of needle rollers.

The present invention is characterized in that the retainer is subjected to a sulphonitriding treatment to form a sulphonitrided layer on a surface of the retainer, and the sulphonitrided layer comprises a nitrogen-compound single-layer deposited on the surface of the retainer made of steel, and a sulfur-compound porous layer formed continuously on the nitrogen-compound single-layer and forming a surface layer of the sulphonitrided layer.

According to the present invention, a sulfur-compound layer is formed in advance on the surface of the retainer in order to prevent a chemical reaction to occur between the retainer and a sulfur component in the engine oil. In addition, the sulfur-compound layer is deposited directly on and integrally with the nitrogen-compound layer through the sulphonitriding treatment. By combinedly forming the sulfur-compound layer and the nitrogen-compound layer as described above, the layer is not easily removed from the retainer as is done in conventional bearings, resulting in the possibility of maintaining the wear resistance for a long time.

Further, because the sulfur-compound layer is a porous layer, oil pockets can be formed to stably hold an oil film. In consequence, it is possible to significantly enhance a reduction in abnormal wearing away and galling of the surface of the retainer. In addition, even if the bearing is sued for a long time and the sulfur-compound layer is worn, because the nitrogen-compound layer is present under the sulfur-compound layer, the wear resistance can be still ensured.

In the present invention, the thickness of the sulphonitrided layer preferably ranges from 5 μm to 20 μm.

According to the present invention, the wear resistance can be maintained for a long time.

Further, in the present invention the retainer preferably has pockets for respectively retaining the plurality of needle rollers, and an entire outer peripheral face of the cylindrical retainer, except the pockets, is preferably designed to be even.

According to the present invention, the contact area of the outer peripheral face of the retainer is increased. As a result, the load per unit area can be reduced, thus further improving the wear resistance.

### BRIEF DESCRIPTION OF THE DRAWINGS

FIG. 1 is a perspective view of a bearing of an embodiment of the present invention.

FIG. 2 is a schematic diagram of the bearing used in a con rod.

FIG. 3 is a schematic diagram illustrating the surface of a retainer.

### BEST MODE FOR CARRYING OUT THE INVENTION

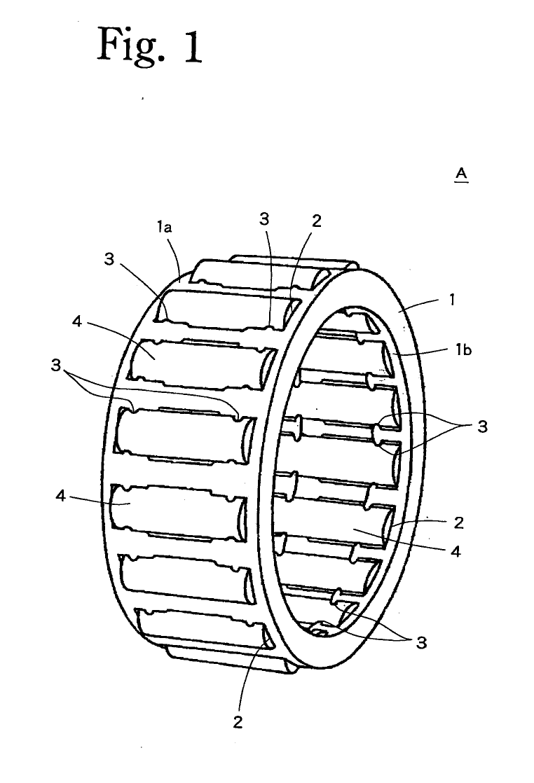

An embodiment of the present invention will be described below with reference to FIG. 1 to FIG. 3.

FIG. 1 is a perspective view illustrating the structure of a bearing A according to the present invention. As is seen from FIG. 1, a hollow cylindrical-shaped steel retainer 1 has a plurality of pockets 2 drilled from an even outer peripheral face 1a to an inner peripheral face 1b. In the retainer 1 a plurality of retaining pieces 3 protrude into each of the pockets 2 and retain a needle roller 4 to prevent it from separating from the pocket 2.

The needle roller 4 retained in each pocket 2 in this way maintains the dimensional relationship that part of the needle roller 4 is exposed from the outer peripheral face 1a and the inner peripheral face 1 of the retainer 1.

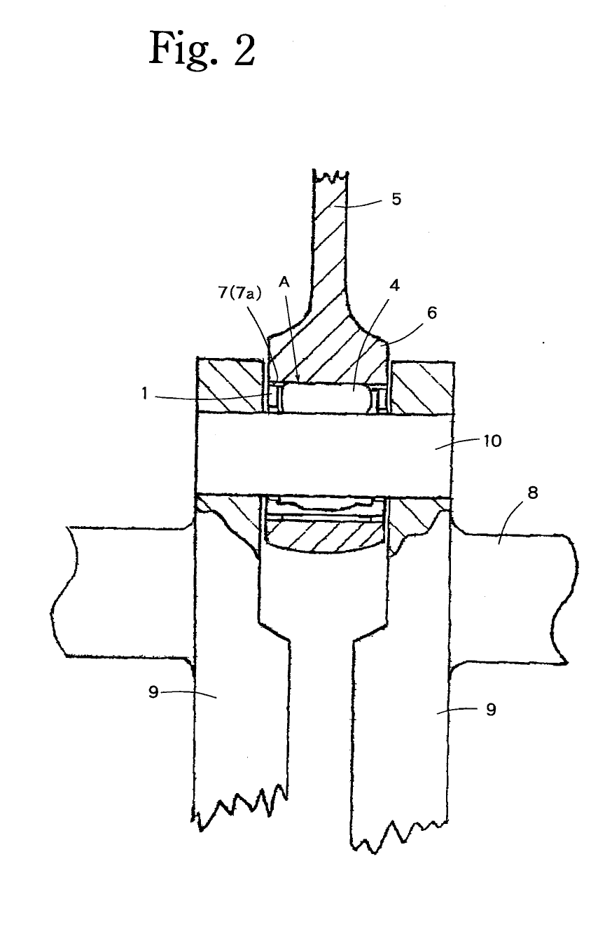

FIG. 2 is a schematic diagram of the bearing A used in a four-cycle engine. Specifically, the bearing A is mounted in a connecting section making a connection between a con rod and a crankshaft.

As is seen from FIG. 2, the con rod 5 has a big end 6 having a connecting hole 7 drilled therethrough. A crankpin 10 is inserted into the connecting hole 7, and then the retainer 1 is fitted directly between the connecting hole 7 and the crankpin 10 to form the bearing A.

The opposing ends of the crankpin 10 are respectively connected to crank journals 8. The crankpins 10 and the crank journals 8 form part of the crankshaft. FIG. 2 shows balance weights 9 respectively attached to the crank journals 8.

When the bearing A supports the crankpin 10, the bearing A maintains the dimensional relationship that the needle rollers 4 held in the retainer 1 are in close contact with the crankpin 10 and the inner wall 7a of the connecting hole 7. That is, even during the rotational motion of the big end 6 of the con rod 5 about the crank journals 8, the needle rollers 4 roll between the crankpin 10 and the inner wall 7a of the connecting hole 7 while making close contact with them.

In this rotational motion, a centrifugal force acts on the bearing A because the big end 6 of the con rod 5 moves in a constant rotational trajectory as described above. Upon the action of the centrifugal force on the bearing A, the retainer 1 receives the centrifugal force, with the result that the retainer 1 follows the rolling motion of the needle rollers 4 while the outer peripheral face 1a is in contact with and slides on the inner wall 7a of the connecting hole 7.

In this manner, because the outer peripheral face 1a of the retainer 1 slides at high speed on the inner wall 7a of the connecting hole 7 while making contact with the inner wall 7a, the outer peripheral 1a is worn in an early stage to cause the seizing of the bearing A. To avoid this, in the embodiment, the surface of the retainer 1 is subjected to a sulphonitriding treatment.

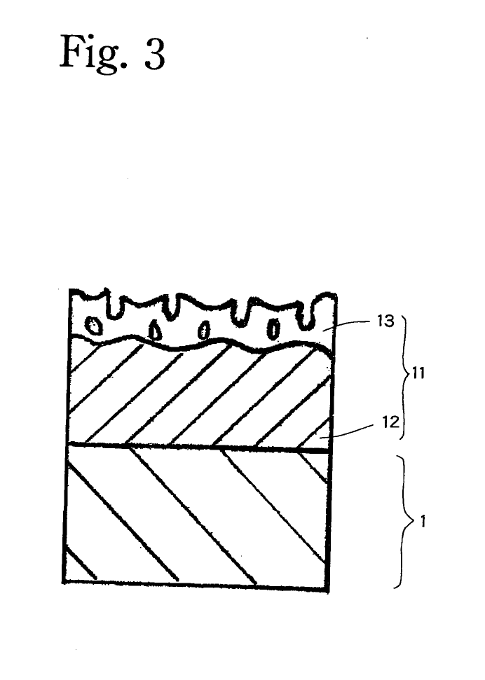

The sulphonitriding treatment is a surface treating method. Specifically, a salt-bath furnace or a gas furnace including sulfur and nitrogen is heated to a set temperature, for example, 540 □C. A steel material to be treated (in this embodiment, the retainer 1) is placed in the heated furnace for 120 minutes to form a compound of sulfur and nitrogen on the surface of the steel material. Accordingly, a sulphonitrided layer 11 is formed on the surface of the steel retainer 1 which has been subjected to the above sulphonitriding treatment as illustrated in FIG. 3.

The sulphonitrided layer 11 includes a nitrogen-compound single layer 12 deposited on the surface of the retainer 1 and a sulfur-compound porous layer 13 deposited on the single-layer 12 and forming the surface layer of the sulphonitrided layer 11. Because the porous layer 13 is capable of stably holding an oil film, the face contact of the retainer 1 in the initial stage of the sliding is improved and the smooth sliding can be maintained for a long time.

On the other hand, the single-layer 12 has high strength, so that the abnormal wearing away and galling of the surface of the retainer 1 are reduced. In addition, since nitrogen atoms diffuse in the retainer 1, the endurance strength of the surface is increased.

A chemical reaction does not occur between the retainer 1 and the sulfur component in the engine oil used in the four-cycle engine, because a sulfur component layer is formed in advance on the outermost face of the retainer 1. In consequence, a coating applied on the surface of the retainer 1 does not chemically react to form a new layer having no bearing on the bonding to the surface of the retainer as is done in conventional art.

In other words, since the sulfur-compound porous layer 13 is deposited directly on and integrally with the nitrogen-compound single-layer 12, even if the retainer is soaked in the sulfur component contained in the engine oil in the four-cycle engine, any chemical reaction does not occur, resulting in the possibility of maintaining the wear resistance for a long time.

When the thickness of the sulphonitrided layer 11 is needlessly thin, the aforementioned advantageous effects cannot be obtained. On the other hand, when the sulphonitrided layer 11 is thicker than necessary, it tends to come off from the surface of the retainer 1. Accordingly, an optimum thickness of the layer 11 ranges from 5 □m to 20 □m for practical use.

In the foregoing embodiment, the entire peripheral face of the retainer 1, except the pockets 2, is designed to be even, but the shape of the retainer is not limited to the embodiment. For example, the retainer may have an M-shaped cross section. However, the contact sliding area of the retainer having an even entire peripheral surface of a cylindrical shape is wider than that of the retainer having an M-shaped cross section. As a result, the load per unit area can be reduced. Because of this and the sulphonitrided layer, a further improvement in wear resistance is achieved.

The foregoing embodiment has described the bearing for use in the con rod. However, the bearing according to the present invention can be widely applied to not only the con rod but also another component as long as it is in the environment causing it to be immersed into the engine oil for the four-cycle engine.

What is claimed is:

1. A bearing for a four-cycle engine comprising a hollow cylindrical retainer made of steel and rotatably retaining a plurality of needle rollers, wherein the retainer is subjected to a sulphonitriding treatment to form a sulphonitrided layer on a surface of the retainer, and the sulphonitrided layer comprises a nitrogen-compound single-layer deposited on the surface of the retainer made of steel, and a sulfur-compound porous layer formed continuously on the nitrogen-compound single-layer and forming a surface layer of the sulphonitrided layer.

2. A bearing for a four-cycle engine according to claim 1, wherein a thickness of the sulphonitrided layer ranges from 5 μm to 20 μm.

3. A bearing for a four-cycle engine according to claim 1, wherein the retainer has pockets for respectively retaining the plurality of needle rollers, and an entire outer peripheral face of the cylindrical retainer, except the pockets, is designed to be even.

4. A bearing for a four-cycle engine according to claim 2, wherein the retainer has pockets for respectively retaining the plurality of needle rollers, and an entire outer peripheral face of the cylindrical retainer, except the pockets, is designed to be even.
